(19) United States
(12) Patent Application Publication
(10) Pub. No.: US 2003/0223332 A1
(43) Pub. Date: Dec. 4, 2003

(54) Optical disk recording apparatus and optical disk recording method

(75) Inventor: Kenji Fukuda, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/448,134

(22) Filed: May 30, 2003

(30) Foreign Application Priority Data
May 31, 2002 (JP) 2002-158901

(51) Int. Cl. G11B 7/0045

(52) U.S. Cl. 369/47.33

(57) ABSTRACT

An optical disk recording apparatus has recording mechanisms which record data in an optical disk while a synchronizing code is inserted into the data at a certain interval, and a system controller which controls so as to resume recording at a position P short of several bytes to the synchronizing code when a data capacity in a data buffer is not more than a first predetermined capacity and then to resume the recording from the suspended position when the data capacity revives to not lower than a second predetermined capacity. The precise synchronizing code can be recorded in such a manner that the synchronizing code is not recorded at the time of recording resumption when recording operation is unstable, and the synchronizing code is recorded besides stabilization of the recording operation after data of several bytes is recorded.

### CROSS-REFERENCE TO RELATED APPLICATIONS

This application is based upon, and claim the benefit of priority from the prior Japanese Patent Application No. 2002-158901, filed May 31, 2002, the entire contents of which are incorporated herein by reference.

### BACKGROUND OF THE INVENTION

1. Field of the Invention

The present invention relates to an optical disk recording apparatus, particularly relates to an optical disk recording apparatus and an optical disk recording method, in which a countermeasure for a buffer underrun is applied.

2. Description of the Related Art

In case where data is recorded into an optical disk medium in an optical disk recording apparatus, e.g., a CD-R drive apparatus, when data transfer speed becomes slower than recording speed of the data, a status in which a data buffer becomes empty and the recording can not be continued, i.e., a buffer underrun error occurs.

With reference to the countermeasure of the buffer underrun, the data amount stored in a data buffer is always observed in the data recording, recording operation is intentionally suspended at the time when the data in the buffer memory falls below a certain level, the data transmitted from a personal computer is stored in the buffer memory during stopping the recording while the status is maintained, and the data recording is resumed from a point where the recording is suspended at the time when the sufficient data is stored.

When the recording is resumed after the buffer underrun occurs, deviation of a bit is generated in a joint part of the data. This is because a clock of a counter, which shows the data position, is changed from a clock of a reproducing system to a clock of a recording system when a mode is changed from a data reproducing state to a data recording state, and these clocks are asynchronous. The generation of the deviation is also caused by a delay between a recording signal and actual laser emission or the like.

A technique shown in Jpn. Pat. Appln. KOKAI Publication No. 2001-216733 is disclosed as the optical disk apparatus having the countermeasure for the buffer underrun. In the technique, the countermeasure for uncertainty of recording processing of the joint part of the data is performed in such a manner that the data is returned to the preceding position earlier than the suspended position and the data is reproduced again.

However, a problem is a synchronizing code recorded at a certain interval in the data in the recording processing, when the suspension and resumption of the recording are performed as the countermeasure for the buffer underrun. That is, in a conventional apparatus, though the recording is always resumed from the synchronizing code, the recording operation is still unstable immediately before and after the resumption of the recording processing and the synchronizing code according to specifications is not often recorded. Therefore, for example, when the synchronizing code is not correctly recorded, since failure of detecting the synchronizing code occurs in the reproducing, there is the problem that the recording data of 588T from the synchronizing code which is the failure of the detection to the next synchronizing code, i.e., 32 bytes can not be reproduced.

Accordingly, in the conventional optical disk recording apparatus, when the recording is suspended by the generation of the buffer underrun and then the recording is resumed, though the resumption of the recording is started from the synchronizing code, the recording operation is unstable at the time when the resuming operation is resumed. Therefore, there is the problem that the synchronizing code of a precise length is not recorded and the 32 bytes after the synchronizing code becomes a reading error of the data in the reproducing.

### BRIEF SUMMARY OF THE INVENTION

In one embodiment of the invention, an optical disk recording apparatus comprises a memory which temporarily stores given data; a recording portion which reads the data stored in the memory, and records the data in a storage region of an optical disk while a synchronizing code is inserted into the data at a predetermined interval; a suspending control portion which controls the recording portion in order to suspend recording of the recording portion at a position located by a predetermined amount previous to the synchronizing code when a capacity of the data stored in the memory becomes not more than a first predetermined capacity; and a resuming control portion which controls the recording portion in order to resume the recording from the position located by the predetermined amount previous to the synchronizing code, where the suspending control portion has suspended the recording, when the capacity of the data stored in the memory becomes not lower than a second predetermined capacity after the suspending control portion suspended the recording.

### BRIEF DESCRIPTION OF THE SEVERAL VIEWS OF THE DRAWING

FIG. 1 is a block diagram showing an outline of an optical disk apparatus according to one embodiment of the invention;

FIG. 2 is a flow chart illustrating recording operation of the optical disk apparatus according to one embodiment of the invention;

FIGS. 3A, 3B are views illustrating failure of detection while resuming after recording is suspended by a buffer underrun in the optical disk apparatus; and

FIGS. 4A, 4B are views illustrating a recording example of a sync code of the optical disk apparatus according to one embodiment of the invention.

### DETAILED DESCRIPTION OF THE INVENTION

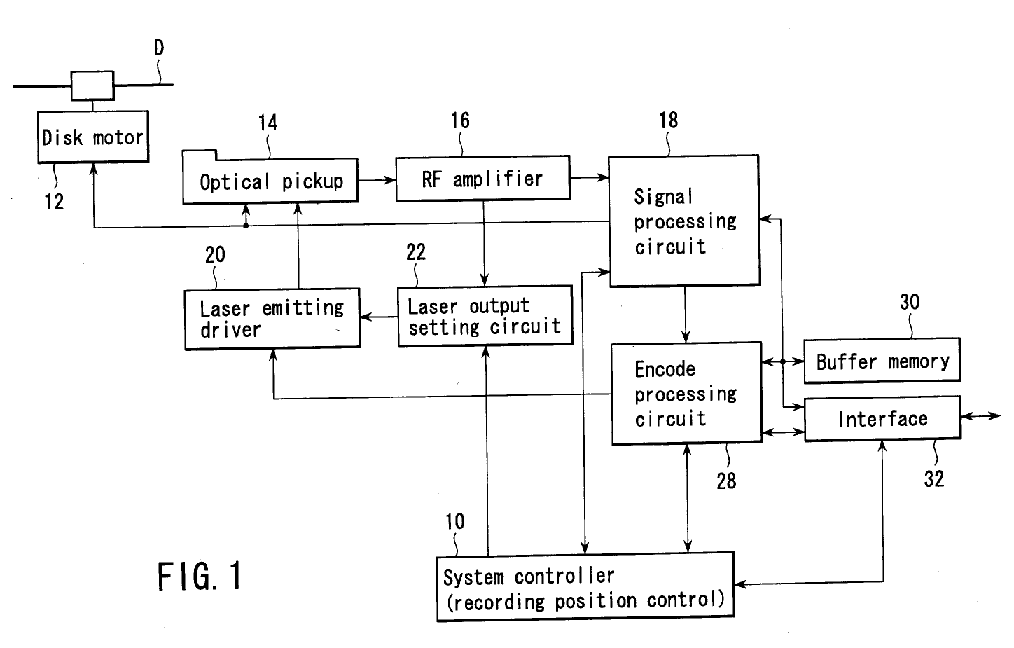

Referring to the figures, an optical disk apparatus according to an embodiment of the invention will be described in detail below. FIG. 1 is a block diagram showing an outline of an optical disk apparatus according to the embodiment of the invention.

(Optical Disk Apparatus According to One Embodiment of the Invention)

In FIG. 1, the optical disk apparatus according to one embodiment of the invention has a disk motor 12 which holds an optical disk D to rotate it at a predetermined number of revolutions, an optical pickup 14 which irradiates the optical disk D with a light beam to detect reflected light, an RF amplifier 16 to which the detected signal is supplied and which generates an RF signal and a servo signal, and a signal processing circuit 18 to which the RF signal is supplied. The optical disk apparatus also has an interface 32 which transmits data to and receives it from the outside, and a buffer memory 30 which is connected to the interface 32 to store temporarily given data or reproducing data read by the optical pickup 14.

Further, the optical disk apparatus has an encode processing circuit 28 which is connected to the buffer memory 30 and the interface 32 to encode the given data, and a laser emitting driver 20 to which an output encoded by the encode processing circuit 28 is supplied. In the laser emitting driver 20, the output is set by a setting signal from a laser output setting circuit 22 which is connected to a system controller 10 controlling the whole of system operation, and the laser beam on the basis of the servo signal supplied from the RF amplifier 16 is generated through the optical pickup 14. The system controller 10 is connected to the above-described components through a data bass to control the operation.

In the optical disk apparatus having the above-described configuration, the reproducing processing of the optical disk is performed as follows. That is, under the control of the system controller 10, the optical disk drive D, which is rotated by the disk motor 12 at the predetermined speed, generates the laser beam according to the laser emitting driver 20 set by the laser output setting circuit 22, its reflected light is detected by the optical pickup 14, and a reproducing signal based on the detection of the reflected light is outputted. The reproducing signal is supplied to the RF amplifier 16, the RF signal outputted from the RF amplifier 16 is supplied to the signal processing circuit 18, and the servo signal outputted from the RF amplifier 16 is supplied to the laser output setting circuit 22. The signal processing circuit 18 decodes the RF signal, and the decoded signal is stored temporarily in the buffer memory 30 or directly outputted external through the interface 32. At this point, the signal processing circuit 18 generates from the servo signal a control signal to control the focusing and the tracking of the optical pickup 14. Further, the signal processing circuit 18 generates from the servo signal a control signal to control the rotation of the disk motor 12.

In the optical disk apparatus having the above-described configuration, the recording processing of the optical disk is performed as follows. That is, under the control of the system controller 10, for example, the data supplied through the interface 32 is temporarily stored in the buffer memory, supplied to the encode processing circuit 28, and then encoded to be outputted. A driver output of the laser emitting driver 20 is supplied to the optical pickup 14 according to the encoded output and the output of the laser output setting circuit 22. In the optical pickup 14, the recording processing is performed in such a manner that the laser beam according to the driver output is emitted from a laser diode mounted on the optical pickup 14 and a storage region of the optical disk D rotated by the disk motor 12 at a predetermined number of revolutions is irradiated with the laser beam.

When the system controller 10 detects the underrun while the recording processing is performed into the optical disk, the recording processing having high reliability can be performed by a characteristic method of one embodiment of the invention, which is described later, in such a manner that the sync code which is controlling data and synchronizing code is securely recorded.

(Description of Operation)

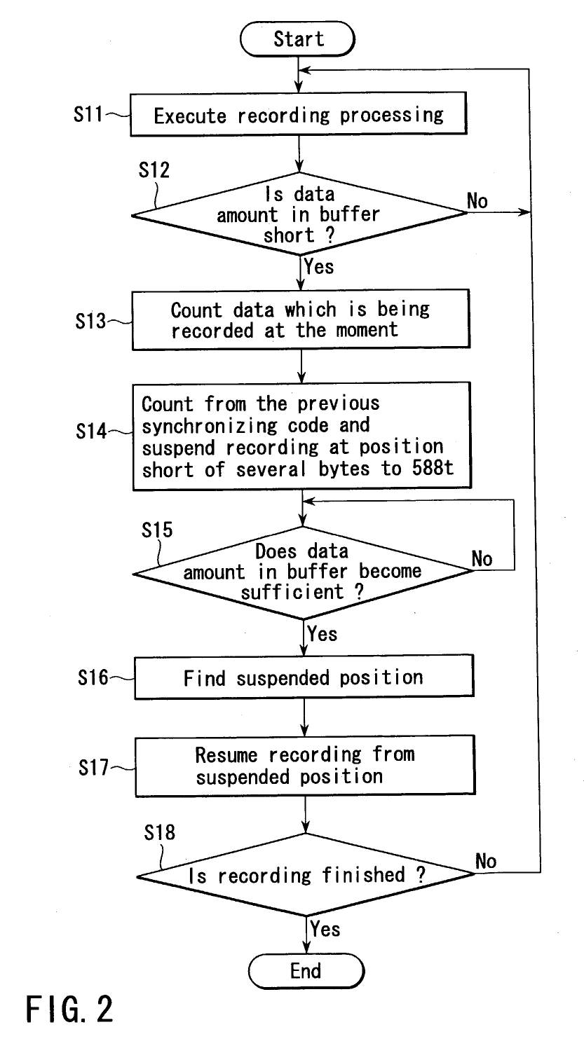

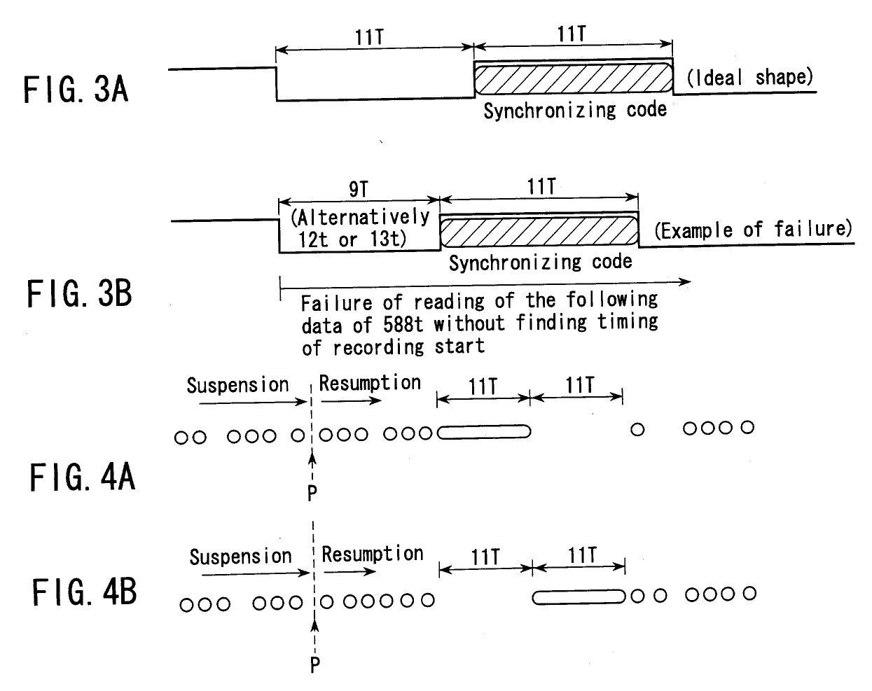

In the recording processing of the optical disk apparatus according to one embodiment of the invention, the processing of the case where the buffer underrun occurs during the recording processing will be described in detail by using the flow chart. FIG. 2 is a flow chart illustrating a recording operation of the optical disk apparatus according to the embodiment of the invention, FIGS. 3A, 3B are views illustrating the failure of the detection while resuming after the recording is suspended by the buffer underrun in the optical disk apparatus, and FIGS. 3A, 3B are views illustrating the recording example of the sync code of the optical disk apparatus according to one embodiment of the invention.

In the flow chart shown in FIG. 2, while the recording processing is performed (S11), capacity of data stored in the buffer memory 30 is always observed. If the capacity of the data becomes not more than a predetermined amount (S12), the system controller 10 is decided as the buffer underrun and the recording processing is temporarily suspended. For example, it is preferable to perform the suspension in the capacity not more than 100 sectors.

At this point, in the conventional apparatus, since positions of the suspension and the resumption are recorded as the sync code of the management code, as shown in FIG. 3A, the sync code of the synchronizing code ideally becomes 11T (T is a time showing 4.3121 MHz at a single-speed and a value of about 230 ns). However, the sync code becomes the value including error such as 9T, 12T, and 13T because the operation is unstable immediately after the recording processing is resumed. Consequently, sometimes there is the case that fails to detect the sync code of the management code when the optical disk is reproduced. In this case, the 32 bytes, which are the recording data of 588T from the synchronizing code to the next synchronizing code, can not be recorded and the data corresponding to the region can not be reproduced.

The embodiment of the invention is to resolve such trouble. When the capacity of the data in the buffer memory 30 becomes sufficient to resume the recording, the recording is not started from the sync code of the synchronizing code, but resumed from a position P short of several bytes to the synchronizing code, as shown in FIGS. 4A, 4B. Accordingly, deviation of the time, shown in FIG. 3B, which is caused by the initially unstable operation of the recording resumption can be avoided, and the sync code of the synchronizing code can be recorded when the operation is relatively stabilized.

Though it is proper that the position P is short of 2 to 3 bytes to the synchronizing code, working-effect can be expected depending on an extent in which the resuming position is moved even when the position P is less than 2 to 3 bytes, and the position P may be also the large value such as 5 bytes, 8 bytes, or more.

When the suspension of the recording processing is decided in step S12 in order that the position of the suspension is equal to the position of the resumption, the counting is performed until the position short of several bytes to 588T from the previous synchronizing code, i.e., the sync code to determine the position, and the recording is suspended (S14). That is, the data stored in the buffer memory 30 is not entirely recorded, and the corresponding data, which follows the position P short of the several bytes to the synchronizing code, is not recorded but saved.

While the status is maintained after the suspension, the data transmitted from a host computer or the like through the interface 32 is stored in the buffer memory 30 during the suspension of the recording, if the data capacity exceeds a predetermined capacity in the buffer memory 30 (S15), the position which has been suspended is found from the stored data in order to resume the recording (S16). The predetermined capacity of the recording resumption is preferable, for example, 100 sectors, but other values may be used. Then, the recording is resumed from the suspended position (S17).

In the resumption of the recording, though a mode of the synchronizing code depends on its specification, there are at least two cases, i.e., a case where the 11T-blank is provided after the 11T-sync code of the synchronizing code as shown in FIG. 3A, and a case where the 11T-sync code of the synchronizing code is provided after the 11T-blank as shown in FIG. 3B.

The recording is resumed as shown in FIGS. 4A, 4B, and the recording is continued until the scheduled recording is completed. If the data capacity becomes short and the status becomes the buffer underrun again (S12), the same processing is repeatedly performed.

In the optical disk apparatus according to one embodiment of the invention, when the status becomes the buffer underrun to suspend the recording and then the recording is resumed, the synchronizing code is securely recorded after the resumption of the recording in such a manner that the positions of the suspension and the resumption are set not from the synchronizing code unlike the prior art, but from the position short of several bytes to the synchronizing code. Consequently, it is possible to provide the optical disk apparatus and the optical disk recording method, which can stably perform the recording operation.

Though a person skilled in the art can realize the invention by the various embodiments described above, various modifications of the embodiments can be easily conceived by a person skilled in the art, and the invention can be applied to various modes without any inventive ability. Accordingly, the invention covers a wide range which is not contradictory to the disclosed principle and novel feature, and it is not limited to the above-described embodiment.

As described above in detail, according to one embodiment of the invention, the recording error of the synchronizing code, which is caused by the unstableness of the recording operation immediately after the resumption of the recording, can be avoided in such a manner that the positions of the suspension and the resumption of the recording, which is caused by the underrun or the like, are set not from the synchronizing code unlike the apparatus of the prior art, but from the position short of several bytes to the synchronizing code. Therefore, it is possible to provide the optical disk apparatus, in which the detecting error of the synchronizing code never occurs in the reproducing and the stable recording operation can be performed even in the case of presence of the buffer underrun.

What is claimed is:

1. An optical disk recording apparatus comprising:
a memory which temporarily stores given data;
a recording portion which reads the data stored in the memory, and records the data in a storage region of an optical disk while a synchronizing code is inserted into the data at a predetermined interval;
a suspending control portion which controls the recording portion in order to suspend recording of the recording portion at a position located by a predetermined amount to the synchronizing code when a capacity of the data stored in the memory becomes not more than a first predetermined capacity; and
a resuming control portion which controls the recording portion in order to resume the recording from the position located by a predetermined amount to the synchronizing code, where the suspending control portion has suspended the recording, when the capacity of the data stored in the memory becomes not lower than a second predetermined capacity after the suspending control portion suspended the recording.

2. An optical disk recording apparatus according to claim 1, wherein the position suspended by the suspending control portion is a position short of several bytes to the synchronizing code.

3. An optical disk recording apparatus according to claim 1, wherein the synchronizing code recorded by the recording portion is recorded as a synchronizing code of 11T and a following blank region of 11T.

4. An optical disk recording apparatus according to claim 1, wherein the synchronizing code recorded by the recording portion is recorded as a blank region of 11T and a following synchronizing code of 11T.

5. An optical disk recording apparatus according to claim 1, wherein the suspending control portion does not entirely record the data stored in the memory, and does not record but saves the following data which corresponds to the position located by the predetermined amount to the synchronizing code in order to suspend the recording of the recording portion to the position by the predetermined amount of the synchronizing code when the capacity of the data stored in the memory becomes not more than the first predetermined capacity.

6. An optical disk recording apparatus according to claim 1, wherein the suspending control portion further has a counter which counts the position until the position comes the predetermined amount to 588T from the previous synchronizing code of the data so that the suspending control portion does not entirely record the data stored in the memory, and does not record but retains the following data which corresponds to the position located by the predetermined amount to the synchronizing code, in order to suspend the recording of the recording portion at the position located by the predetermined amount previous to the synchronizing code when the capacity of the data stored in the memory becomes not more than the first predetermined capacity.

7. An optical disk recording method comprising:
storing temporarily given data;
reading the stored data and recording the data in a storage region of an optical disk while a synchronizing code is inserted into the data at a predetermined interval;
suspending recording at a position located by a predetermined amount to the synchronizing code when a capacity of the data stored in the memory becomes not more than a first predetermined capacity; and
resuming the recording from the position located by the predetermined amount to the synchronizing code when the capacity of the data stored in the memory becomes not lower than a second predetermined capacity after the suspending control portion suspended the recording.

8. An optical disk recording method according to claim 7, wherein the position to be suspended is a position short of several bytes to the synchronizing code.

9. An optical disk recording method according to claim 7, wherein the synchronizing code to be recorded is recorded as a synchronizing code of 11T and a following blank region of 11T.

10. An optical disk recording method according to claim 7, wherein the synchronizing code to be recorded is recorded as a blank region of 11T and a following synchronizing code of 11T.

11. An optical disk recording method according to claim 7, wherein the stored data is not entirely recorded, and the following data which corresponds to the position located by the predetermined amount to the synchronizing code is not recorded but saved, in order to suspend the recording of the recording portion previous to the position by the predetermined amount of the synchronizing code when the capacity of the stored data becomes not more than the first predetermined capacity.

12. An optical disk recording method according to claim 7, wherein, in the suspension, the counting is performed until the position comes the predetermined amount previous to 588T from the synchronizing code of the data so that the stored data is not entirely recorded, the following data which corresponds to the position located by the predetermined amount to the synchronizing code is not recorded but saved, in order to suspend the recording at the position located by the predetermined amount previous to the synchronizing code when the capacity of the stored data becomes not more than the first predetermined capacity.

13. An optical disk recording apparatus comprising:
a memory means for temporarily storing given data;
a recording means for reading the data stored in the memory, and recording the data in a storage region of an optical disk while a synchronizing code is inserted into the data at a predetermined interval;
a suspending control means for controlling the recording means in order to suspend recording of the recording means at a position located by a predetermined amount to the synchronizing code when a capacity of the data stored in the memory becomes not more than a first predetermined capacity; and
a resuming control means for controlling the recording means in order to resume the recording from the position located by a predetermined amount to the synchronizing code, where the suspending control means has suspended the recording, when the capacity of the data stored in the memory becomes not lower than a second predetermined capacity after the suspending control means suspended the recording.

14. An optical disk recording apparatus according to claim 13, wherein the position suspended by the suspending control means is a position short of several bytes to the synchronizing code.

15. An optical disk recording apparatus according to claim 13, wherein the synchronizing code recorded by the recording means is recorded as a synchronizing code of 11T and a following blank region of 11T.

16. An optical disk recording apparatus according to claim 13, wherein the synchronizing code recorded by the recording means is recorded as a blank region of 11T and a following synchronizing code of 11T.

17. An optical disk recording apparatus according to claim 13, wherein the suspending control means does not entirely record the data stored in the memory, and does not record but saves the following data which corresponds to the position located by the predetermined amount to the synchronizing code in order to suspend the recording of the recording means to the position by the predetermined amount of the synchronizing code when the capacity of the data stored in the memory becomes not more than the first predetermined capacity.

18. An optical disk recording apparatus according to claim 13, wherein the suspending control means further has a counter means for counting the position until the position comes the predetermined amount to 588T from the previous synchronizing code of the data so that the suspending control means does not entirely record the data stored in the memory, and does not record but retains the following data which corresponds to the position located by the predetermined amount to the synchronizing code, in order to suspend the recording of the recording means at the position located by the predetermined amount previous to the synchronizing code when the capacity of the data stored in the memory becomes not more than the first predetermined capacity.
